(19) United States
(12) Patent Application Publication
(10) Pub. No.: US 2025/0216641 A1
(43) Pub. Date: Jul. 3, 2025

(54) CABLE SEAL STRUCTURALLY CONFIGURED TO PROVIDE A WATERPROOF SEAL BETWEEN A HOUSING PORTION AND A SURFACE SURROUNDING A PASS-THROUGH PORT OF A SUBMERSIBLE ENCLOSURE

(71) Applicant: PPC BROADBAND, INC., East Syracuse, NY (US)

(72) Inventors: Nicholas CLAVER, Liverpool, NY (US); Cameron ADAMS, Camillus, NY (US)

(73) Assignee: PPC BROADBAND, INC., East Syracuse, NY (US)

(21) Appl. No.: 19/005,227

(22) Filed: Dec. 30, 2024

Related U.S. Application Data
(60) Provisional application No. 63/616,361, filed on Dec. 29, 2023.

(51) Int. Cl. G02B 6/44; G02B 6/50

(52) U.S. Cl. CPC G02B 6/44775; G02B 6/506

(57) ABSTRACT

A cable sealing device structurally configured to form a watertight seal where a communication cable is received through a pass-through port. The cable sealing device may include a housing portion structurally configured to mount onto the cable and a sealing member at least partially housed in an interior space of the housing portion. The sealing member being structurally configured to create a seal between the housing portion and the cable and/or between a first end portion of the housing portion and a surface surrounding the pass-through port to enhance simplicity of installation and sealing effectiveness of the sealing device.

### CROSS-REFERENCE TO RELATED APPLICATIONS

This application claims the benefit of U.S. Provisional Patent Application No. 63/616,361, filed Dec. 29, 2023, the disclosure of which is hereby incorporated by reference herein in its entirety.

### TECHNICAL FIELD

The present disclosure relates generally to cable sealing devices, and more particularly to a cable seal structurally configured to form a waterproof sealing portion that is structurally configured to seal between an end face portion of a housing portion and a surface surrounding a pass-through port of a submersible enclosure.

### BACKGROUND

Fiber optic networks use fiber optic cable enclosures that are configured to handle different connectivity solutions (e.g., looped cable storage, splicing, and patching). In some applications, the fiber optic cable enclosures are mounted underwater or otherwise exposed to water or moisture. In these cases, the enclosures must be sealed to prevent water from entering.

Many enclosures require a pass-through port design which accepts a cable that has already been terminated with connectors or is prepared as a midspan. Standard seal designs on pass-through ports are typically not adequate for underground/submersed environments. Existing seal designs that are specifically adapted for submersible enclosures are time and labor intensive—typically utilizing several screws, grommets that need to be slit, and a lubricating grease.

There is a need for a simple to use pass-through port seal design that provides reliable sealing on a submersible enclosure. Accordingly, it may be desirable to provide a cable seal having a housing portion that is structurally configured to deform a sealing portion in the housing portion such that a portion of the sealing portion is urged from an interior space of the housing portion so as to form a waterproof sealing portion exterior to the housing portion that is structurally configured to seal against a wall of a submersible enclosure.

### SUMMARY

The present disclosure provides cable sealing device to enhance simplicity of installation and sealing effectiveness of the sealing device. In some implementations, the cable sealing device 100 is structurally configured to mount onto a cable (e.g., a communication cable, such as a fiber optic cable). In some implementations, the cable sealing device is structurally configured to provide a seal around the cable and/or provide a seal between the cable sealing device and another surface (e.g., a wall of an enclosure). In some implementations, the cable sealing device is structurally configured to form a seal around a cable and a pass-through port of an enclosure that surrounds the cable. In some implementations, the cable sealing device is structurally configured to form an effective underwater seal for use with a submersible enclosure.

In some embodiments, the sealing device may include a housing portion structurally configured to mount onto a communication cable and a sealing portion at least partially positioned in an interior space of the housing portion.

In some embodiments, the housing portion may include a first end face portion having a first receiving portion structurally configured to receive the communication cable therethrough, a second end face portion having a second receiving portion structurally configured to receive the communication cable therethrough, and a sidewall portion extending between the first end face portion and the second end face portion.

In some embodiments, the sidewall portion, the first end face portion, and the second end face portion may be configured to define the interior space.

In some embodiments, the sealing portion may be structurally configured to create a water-proof seal between the housing portion and a communication cable.

In some embodiments, the housing portion may include a first housing portion and a second housing portion. In some embodiments, the first housing portion may be connected to the second housing portion by a hinged connection portion. In some embodiments, the first housing portion may be structurally configured to pivot relative to the second housing portion between an open state, wherein the interior space, the first receiving portion, and the second receiving portion are structurally configured to receive a communication cable, and a closed state, wherein the first housing portion and the second housing portion are structurally configured to surround the communication cable as the communication cable extends through the interior space, the first receiving portion, and the second receiving portion.

In some embodiments, the first receiving portion may include a first opening having a first diameter and the second receiving portion may include a second opening having a second diameter that is smaller than the first diameter.

In some embodiments, the first housing portion and the second housing portion may be structurally configured, when closing around the communication cable, to deform the sealing portion such that a part of the sealing portion is urged from the interior space through the first receiving portion so as to form a waterproof sealing portion outside of the interior space and that is structurally configured to seal around the communication cable outside of the interior space and to seal between the first end face portion and a surface surrounding a cable pass-through port associated with a submersible enclosure wherein the communication cable extends through the cable pass-through port to enhance simplicity of installation and sealing effectiveness of the sealing device.

In some embodiments, the actuating portion may be structurally configured to deform the sealing portion such that the part of the sealing portion is urged from the interior space through the first opening, wherein the actuation portion is structurally configured to thread into the housing portion.

In some embodiments, the cable sealing device may include a retaining portion structurally configured to lock the housing portion in the closed state.

In some embodiments, the cable sealing device may be structurally configured to form a watertight seal where a communication cable is received through a pass-through port.

In some embodiments, the cable sealing device may include housing portion structurally configured to mount onto a communication cable and a sealing portion at least partially positioned in an interior space of the housing portion.

In some embodiments, the housing portion may include a first end portion having a first receiving portion structurally configured to receive the communication cable therethrough, a second end portion having a second receiving portion structurally configured to receive the communication cable therethrough, and a sidewall portion extending between the first end portion and the second end portion. In some embodiments, the sidewall portion, the first end portion, and the second end portion may be structurally configured to define the interior space.

In some embodiments, the sealing portion may be structurally configured to create a water-proof seal between the housing portion and a communication cable.

In some embodiments, the first receiving portion may include a first opening having a first diameter and the second receiving portion may include a second opening having a second diameter that is smaller than the first diameter.

In some embodiments, the housing portion may be structurally configured to deform the sealing portion such that a part of the sealing portion is urged from the interior space through the first receiving portion so as to form a waterproof sealing portion that structurally configured to seal around the communication cable outside of the interior space and to seal between the first end portion and a surface surrounding a cable pass-through port associated with a submersible enclosure wherein the communication cable extends through the cable pass-through port to enhance simplicity of installation and sealing effectiveness of the sealing device.

In some embodiments, the housing portion may include a first housing portion structurally configured to move relative to a second housing portion.

In some embodiments, the first housing portion may be structurally configured to pivot relative to the second housing portion between an open state, wherein the interior space, the first receiving portion, and the second receiving portion are structurally configured to receive a communication cable, and a closed state, wherein the first housing portion and the second housing portion are structurally configured to surround the communication cable as the communication cable extends through the interior space.

In some embodiments, the retaining portion may be structurally configured to lock the first housing portion and the second housing portion in the closed state.

In some embodiments, the actuating portion may be structurally configured to move within the interior space to apply a force to the sealing portion to form the waterproof sealing portion that is outside of the interior space.

In some embodiments, the actuating portion may be structurally configured to thread into the housing portion to apply an axial force onto the sealing portion.

In some embodiments, a sealing device may include a housing portion defining an interior space structurally configured to receive a communication cable extending therethrough and a sealing portion at least partially positioned in the interior space.

In some embodiments, the sealing portion and housing portion may be structurally configured to surround the communication cable as the communication cable extends through the interior space.

In some embodiments, the sealing portion may be structurally configured to create a water-proof seal between the housing portion and the communication cable.

In some embodiments, the housing portion may be structurally configured to deform the sealing portion such that a part of the sealing portion is urged from the interior space to form a waterproof sealing portion that is outside of the interior space and that is structurally configured to seal around the communication cable outside of the interior space and to seal between the housing portion and a surface surrounding a cable pass-through port associated with a submersible enclosure wherein the communication cable extends through the cable pass-through port to enhance simplicity of installation and sealing effectiveness of the sealing device.

In some embodiments, the housing portion may include a first end portion having a first receiving portion structurally configured to receive the communication cable therethrough.

In some embodiments, the housing portion may include a second end portion having a second receiving portion structurally configured to receive the communication cable therethrough, wherein the second end portion is opposite the first end portion.

In some embodiments, the housing portion may include a sidewall portion extending between the first end portion and the second end portion, wherein the sidewall portion, the first end portion, and the second end portion define the interior space.

In some embodiments, the first receiving portion may include a first opening having a first diameter and the second receiving portion comprises a second opening having a second diameter that is smaller than the first diameter. In some embodiments, the part of the sealing portion that is urged from the interior space extends through the first opening.

In some embodiments, the housing portion may include a first housing portion structurally configured to move relative to a second housing portion between an open state, wherein the interior space may be structurally configured to receive the communication cable, and a closed state, wherein the first housing portion and the second housing portion may be structurally configured to surround the communication cable as the communication cable extends through the interior space.

In some embodiments, first housing portion may be structurally configured to pivot relative to the second housing portion.

In some embodiments, the first housing portion may be connected to the second housing portion by a hinged connection portion.

In some embodiments, the cable sealing device may include a retaining portion structurally configured to lock the first housing portion and the second housing portion in the closed state.

In some embodiments, the cable sealing device may include an actuating portion structurally configured to move within the interior space to apply a force to the sealing portion to form the waterproof sealing portion that is exterior to the housing portion.

In some embodiments, the actuation portion may be structurally configured to thread into the housing portion to apply an axial force onto the sealing portion.

In some embodiments, the cable sealing device may include a supporting portion structurally configured to secure the housing portion in position relative to the surface surrounding the cable pass-through port.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a schematic illustration of an example cable sealing device in accordance with various aspects of the disclosure mounted on a cable and sealing against an enclosure.

FIG. 2 is a perspective view of an example cable sealing device in accordance with various aspects of the disclosure.

FIG. 3 is a perspective view of the cable sealing device of FIG. 2 in an open configuration.

FIG. 4 is a perspective view of the cable sealing device of FIG. 2 in an open configuration with the cable located in a position to be captured.

FIG. 5 is a section view of the cable sealing device of FIG. 2 mounted onto a cable.

FIG. 6 is perspective view of the cable sealing device of FIG. 2 sealing against a wall of an enclosure.

FIG. 7 section view of an example cable sealing device in accordance with various aspects of the disclosure mounted onto a cable.

FIG. 8 is a section view an example cable sealing device in accordance with various aspects of the disclosure mounted onto a cable.

FIG. 9 is an isometric view an example cable sealing device with an example device for supporting the cable sealing device against a wall of an enclosure.

FIG. 10 is an isometric view an example cable sealing device with an example device for supporting the cable sealing device against a wall of an enclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

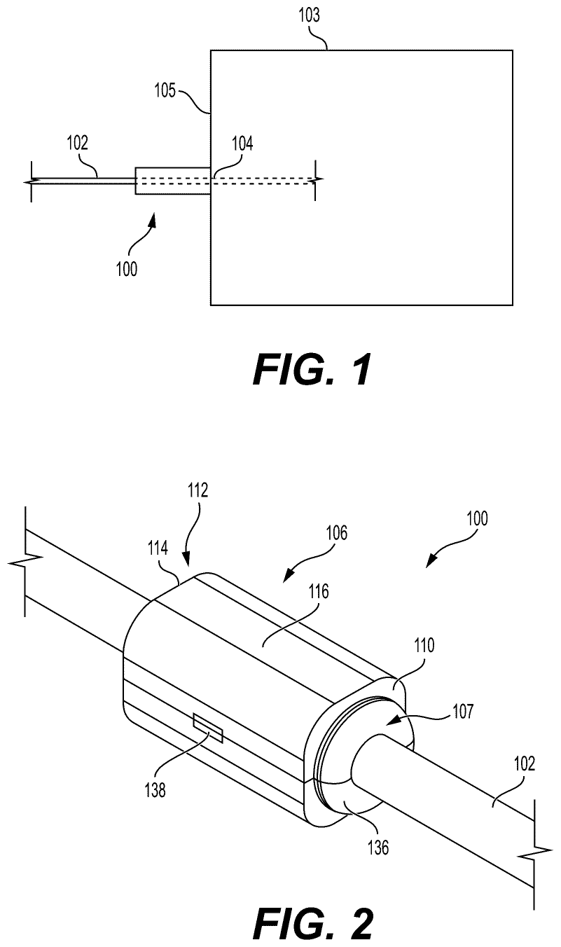

Embodiments of the disclosure provide a cable sealing device 100 for a cable 102 (e.g., a communication cable such as a fiber optic cable). The cable sealing device 100 may be structurally configured for the cable 102 to extend through cable sealing device 100 as shown schematically in FIG. 1. For example, in some implementations, the cable sealing device 100 may be structurally configured to mount onto the cable 102. In some implementations, the cable sealing device 100 may be structurally configured to provide a seal around the cable 102 and/or provide a seal between the cable sealing device 100 and another surface. For example, in some implementations, the cable 102 may be routed into an enclosure 103 that provides one or more system functions such as, for example, cable storage, splicing, splitting, patching, etc. The cable 102 may extend through a pass-through port 104 in a wall portion 105 of the enclosure and the cable sealing device 100 may be structurally configured to seal against the wall portion 105 to provide a seal around the pass-through port 104.

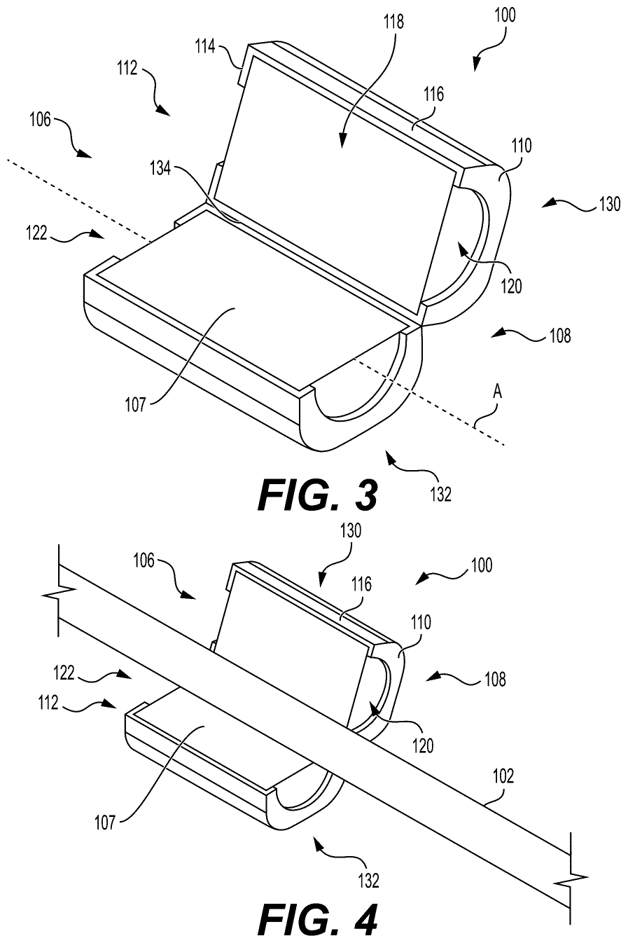

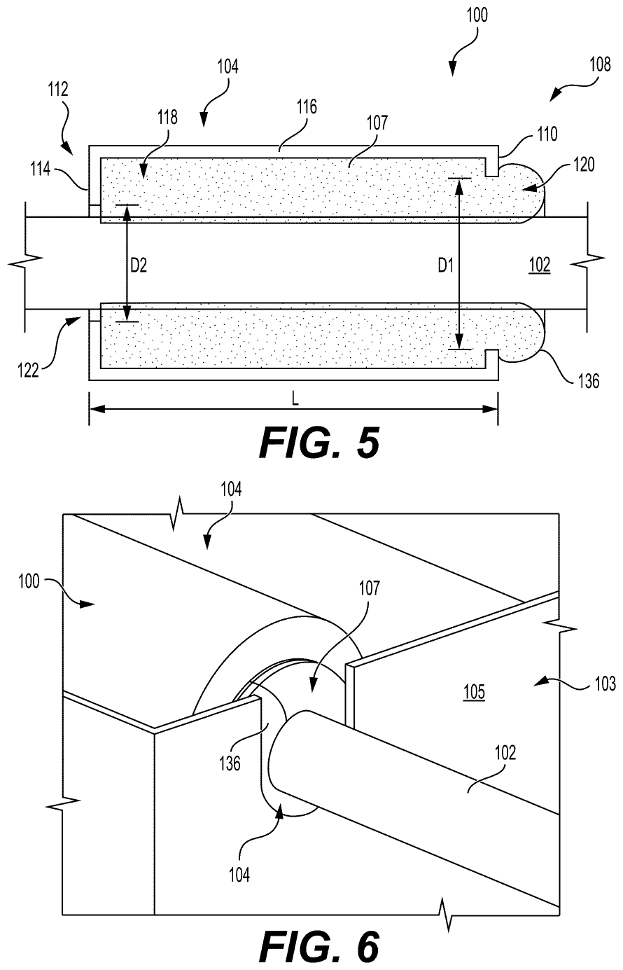

FIGS. 2-6 show an example cable sealing device 100. The example cable sealing device 100 may include a housing portion 106 and a sealing portion 107. The housing portion 106 may be structurally configured to mount onto the cable 102 and may be structurally configured to house at least a portion of the sealing portion 107. The housing portion 106 may be structurally configured in a variety of ways. In some implementations, the housing portion 106 may have a first end portion 108 with a first end face portion 110 and a second end portion 112 with a second end face portion 114 opposite the first end face portion 110. The housing portion 106 may have a longitudinal axis A (FIG. 3), a longitudinal length L (FIG. 5), and may include one or more sidewall portions 116 extending between the first end portion 108 and the second end portion 112.

The one or more sidewall portions 116 may be structurally configured in a variety of ways. For example, the housing portion 106 may be in a variety of shapes. In the illustrated example, the one or more sidewall portions 116 may form a generally cuboid shape with rounded or curved corners between the one or more sidewall portions 116. In other implementations, however, the housing portion 106 may be cylindrical, may have an oval or elliptical cross-section, or may be any other suitable configuration.

In some implementations, the one or more sidewall portions 116, the first end portion 108, and the second end portion 112 may define an interior space 118. In some implementations, the interior space 118 may extend within the housing portion 106 from adjacent the first end face portion 110 to adjacent the second end face portion 114. For example, the interior space 118 may extend greater than 90% of the length L of the housing portion 106. In other embodiments, however, the interior space 118 may extend less than 90% of the length L (e.g., less than 75% of the length).

In some implementations, the first end portion 108 may include a first receiving portion 120 (e.g., an opening) extending through the first end portion 108 from the first end face portion 110 to the interior space 118. In some implementations, the first receiving portion 120 may be structurally configured to receive the cable 102 therethrough. The first receiving portion 120 may be structurally configured in a variety of ways, including shape, size, location on the first end face portion 110. In some implementations, the first receiving portion 120 may be circular and centered on the first end face portion 110 about the longitudinal axis A. In other implementations, the first receiving portion 120 may be shaped other than circular and may be positioned on the first end face portion 110 other than centered on the longitudinal axis A (e.g., offset from the longitudinal axis A). In some implementations, the first receiving portion 120 may have a diameter D1.

In some implementations, the second end portion 112 may include a second receiving portion 122 extending through the second end portion 112 from the second end face portion 114 to the interior space 118. In some implementations, the second receiving portion 122 may be structurally configured to receive the cable 102 therethrough. The second receiving portion 122 may be structurally configured in a variety of ways, including shape, size, location on the second end face portion 114. In some implementations, the second receiving portion 122 may be circular and centered on the second end face portion 114 about the longitudinal axis A. In other implementations, the second receiving portion 122 may be shaped other than circular and may be positioned on the second end face portion 114 other than centered on the longitudinal axis A (e.g., offset from the longitudinal axis A). In some implementations, the second receiving portion 122 may have a diameter D2.

The housing portion 106 may be structurally configured to mount onto the cable 102 in a variety of ways. In some implementations, the housing portion 106 may be structurally configured to open along the length L of the housing portion 106 to receive the cable 102 within the interior space 118. For example, in some implementations, the housing portion 106 may include a first portion 130 (e.g., top portion or right portion) and a second portion 132 (e.g., bottom portion or left portion) opposite the first portion 130. The first portion 130 may be structurally configured to move relative to the second portion 132, or vice versa, between an open state, as shown in FIGS. 3-4, and a closed state, as shown in FIGS. 2 and 5.

In some implementations, the first portion 130 may be structurally configured to define a first half or top half of the housing portion 106 and the second portion 132 may be structurally configured to define a second half or bottom half of the housing portion 106. In some implementations, the first portion 130 may be structurally configured to define a first half or top half of the first receiving portion 120 and the second receiving portion 122 and the second portion 132 may be structurally configured to define a second half or bottom half of the first receiving portion 120 and the second receiving portion 122.

In some implementations, in the open state, the housing portion 106 may be structurally configured such that the communication cable 102 may be received in the interior space 118, the first receiving portion 120, and the second receiving portion 122. In the closed state, the housing portion 106 may be structurally configured to wrap around the cable 102. In some implementations, in the open state, the housing portion 106 may be structurally configured such that at least a portion of the first portion 130 may be moved away from the second portion 132. For example, in some implementations, the first portion 130 may be connected to the second portion 132 by a hinge or another type of pivot connection or a separable connection. In some implementations, the first portion 130 may be structurally configured to pivot relative to the second portion 132 via a hinged connection portion 134. The hinged connection portion 134 may be structurally configured in a variety of ways, such as for example, a mechanical hinge or a living hinge.

The sealing portion 107 may be structurally configured to create a seal (e.g., water-proof seal) between the housing portion 106 and the cable 102 and between the first end face portion 110 and the wall portion 105 of the enclosure 103 surrounding the pass-through port 104. In some implementations, the sealing portion 107 may be structurally configured to be at least partially housed within the interior space 118 of the housing portion 106. For example, in some implementations, prior to the cable 102 being received in the interior space 118 and the housing portion 106 moving from the open state to the closed state, the entire sealing member 107 may be housed within the interior space 118.

In some implementations, the sealing portion 107 may be structurally configured to change shape (i.e., deform) such that part of the sealing portion 107 may extend from the interior space 118 out of the first receiving portion 120. For example, when the cable 102 is received in the interior space 118 and the housing portion 106 moves from the open state to the closed state, the sealing portion 107 may deform such that part of sealing portion 107 may extend outward from the interior space 118 through the first receiving portion 120 to form an exterior sealing portion 136.

The sealing portion 107 may be structurally configured in a variety of ways. Any sealing portion 107 that may create a seal between the housing portion 106 and the cable 102 and between the first end face portion 110 and the wall portion 105 of the enclosure 103 surrounding the pass-through port 104 as well as be deformed to extend outward from the interior space 118 through the first receiving portion 120 may be used. In some implementations, the sealing portion 107 may be a soft gel or soft rubber material. In some implementations, the sealing portion 107 may be structurally configured to form an effective underwater seal for use with a submersible enclosure.

In an example process of the cable sealing device 100 forming a seal with the cable 102 and the enclosure 103, the cable 102 may be first routed through the pass-through port 104 of the enclosure 103. In some implementations, however, the cable sealing device 100 may be attached onto the cable 102 prior to the cable 102 being routed through the pass-through port 104. As shown in FIG. 4, the cable sealing device 100, in the open state, may be positioned such that the cable 102 is between the first portion 130 and the second portion 132, or over and adjacent the second portion 132.

The cable sealing device 100 may then be moved from the open state to the closed state. In some implementations, the first portion 130 may pivot toward the second portion 132 to wrap around the cable 102. In some implementations, the first portion 130 and the second portion 132 may fully, or nearly fully, wrap around the perimeter of the cable 102. In some implementations, the housing portion 106 may include a retaining portion 138 (FIG. 2) that retains or locks the housing portion 106 in the closed state. The retaining portion 138 may be structurally configured in a variety of ways, such as, for example, a latch, a detent, a catch, a snap closure, an interference fit, a clasp, a clip, etc.

When the cable sealing device 100 moves from the open state to the closed state with the cable 102 received within in the interior space 118, the first receiving portion 120, and the second receiving portion 122, the cable 102 may displace or deform the sealing portion 107 resulting in the sealing portion 107 surrounding and forming a seal around the cable 102 within the interior space 118.

Further, when the cable 102 displaces or deforms the sealing portion 107, a part of the sealing portion 107 may extend through the first receiving portion 120 to form the exterior sealing portion 136. The first receiving portion 120 and the second receiving portion 122 may be structurally configured such that the exterior sealing portion 136 may be formed at the first end face portion 110 (i.e., through the first receiving portion 120). For example, in some implementations, the diameter D1 of the first receiving portion 120 may be sufficiently larger than the diameter D2 of the second receiving portion 122 such that the first opening 120 is the path of least resistance for the part of the sealing portion 107 that is displaced or deformed.

In some implementations, the second receiving portion 122 may be structurally configured to inhibit the displaced or deformed portion of the sealing portion 107 from extending through the second receiving portion 122. For example, the diameter D2 of the second receiving portion 122 may be sized to be about the same size as a diameter DC of the cable 102, thus effectively blocking or inhibiting the sealing receiving portion 107 from extending through the second receiving portion 122 when deformed or displaced. The diameter D1 and the diameter D2 may be selected such that the cable sealing device 100 can be effectively used with a variety of cable diameters DC.

To seal against the wall portion 105 of the enclosure 103, the cable sealing device 100 may be positioned adjacent the wall portion 105 such that the exterior sealing portion 136 is sandwiched (e.g., compressed) between the wall portion 105 and the first end face portion 110 to seal around the pass-through port 104. In some implementations, the cable sealing device 100 may be positioned adjacent the wall portion 105 prior to moving to the closed state. In other implementations, the cable sealing device 100 may be moved relative to the cable 102 to bring the exterior sealing portion 136 into contact with and seal against the wall portion 105.

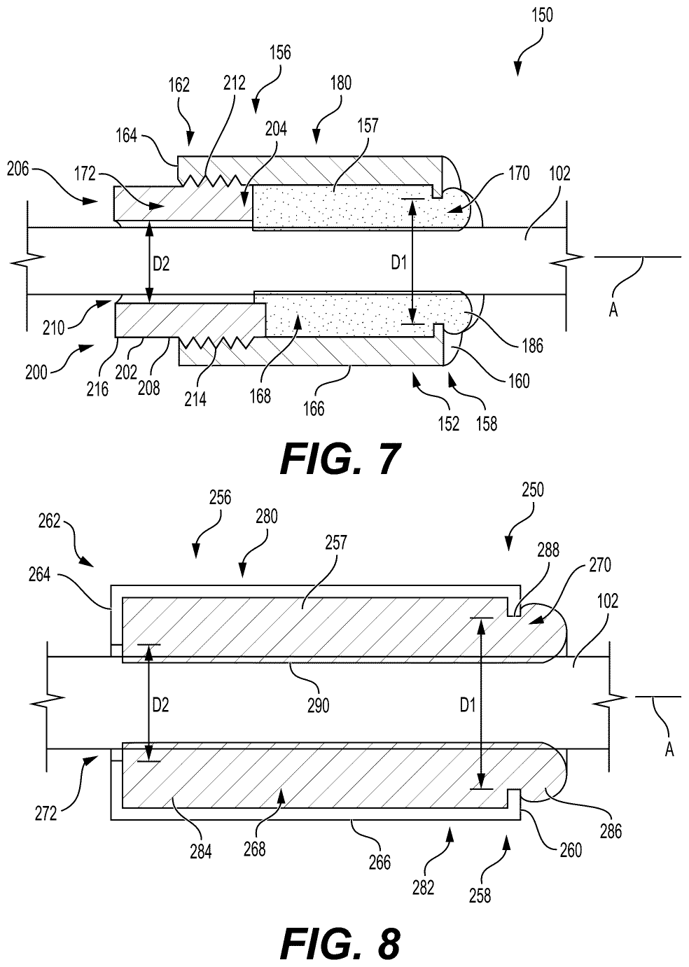

FIG. 7 illustrates an example cable sealing device 150 for the cable 102 (e.g., a communication cable such as a fiber optic cable). The cable sealing device 150 of FIG. 7 is substantially similar to the cable sealing device 100 of FIGS. 2-6 and the description of the cable sealing device 100 applies equally to the cable sealing device 150. For example, in some implementations, the cable sealing device 150 may include a housing portion 156 and a sealing portion 157. The housing portion 156 may be structurally configured to mount onto the cable 102 and may be structurally configured to house at least a portion of the sealing portion 157.

In some implementations, the housing portion 156 may have a first end portion 158 with a first end face portion 160 and a second end portion 162 with a second end face portion 164 opposite the first end face potion 160. The housing portion 156 may have a longitudinal axis A and may include one or more sidewall portions 166 extending between the first end portion 158 and the second end portion 162.

The one or more sidewall portions 166, the first end portion 158, and the second end portion 162 may define an interior space 168. In some implementations, the first end portion 158 may include a first receiving portion 170 extending through the first end portion 158 from the first end face portion 160 to the interior space 168. The first receiving portion 120 may be structurally configured to receive the cable 102 therethrough and may have a diameter D1. In some implementations, the second end portion 162 may include a second receiving portion 172.

The housing portion 156 may be structurally configured to mount onto the cable 102 in a variety of ways. In some implementations, the housing portion 156 may be structurally configured to open along a length of the housing portion 156 to receive the cable 102 within the interior space 168. For example, in some implementations, the housing portion 106 may include a first portion 180 (e.g., top portion or right portion) and a second portion 182 (e.g., bottom portion or left portion) opposite the first portion 180. The first portion 180 may be structurally configured to move relative to the second portion 182, or vice versa, between an open state and a closed state, similar to the cable sealing device 100.

In some implementations, the sealing portion 157 may be structurally configured to create a seal (e.g., water-proof seal) between the housing portion 156 and the cable 102 and between the first end face portion 160 and the wall portion 105 of the enclosure 103 surrounding the pass-through port 104 (FIG. 1). In some implementations, the sealing portion 157 may be structurally configured to change shape (i.e., deform) such that a part of the sealing portion 157 may extend from the interior space 168 out of the first receiving portion 170.

Unlike the cable sealing device 100 which, when the cable sealing device 100 moves to the closed state, uses the cable 102 to displace or deform the sealing portion 107, the cable sealing device 150 may include an actuating portion 200 structurally configured to apply a force to the sealing portion 157 to displace or deform the sealing portion 157 causing a part of the sealing portion 157 to extend through the first receiving portion 170.

The actuating portion 200 may be structurally configured in a variety of ways. Any configuration that can displace or deform the sealing portion 157 to cause a part of the sealing portion 157 to extend through the first receiving portion 170 may be used. In some implementations, the actuating portion 200 may be structurally configured to apply a longitudinal force on the sealing portion 157 in the direction of the first receiving portion 170. For example, the actuating portion 200, in some implementations, may be a piston, a plunger, a driver, etc.

In some implementations, the actuating portion 200 may include a body portion 202 having a first end portion 204, a second end portion 206 opposite the first end portion 204, and a side wall portion 208 extending between the first end portion 204 and the second end portion 206. In some implementations, the side wall portion 208 may be cylindrical.

In some implementations, the first end portion 204 may be structurally configured to be received within the second receiving portion 172 of the second end portion 162 of the housing portion 156. The actuation portion 200 may include a longitudinal passage 210 extending through the actuation portion 200 from the first end portion 204 to the second end portion 206. In some implementations, the longitudinal passage 210 may be structurally configured to receive the cable 102. In some implementations, the longitudinal passage 210 may have a diameter D2.

In some implementations, the actuating portion 200 may include an external threaded portion 212 on at least a part of the side wall portion 208 and the second end portion 162 of the housing portion 156 may include an internal threaded portion 214 structurally configured to mate with the external threaded portion 212. In some implementations, the second end portion 206 of the actuation portion 200 may include a tool engagement portion 216 (e.g., a hex head) structurally configured for engagement by a tool (e.g., a wrench) to rotate the actuating portion 200 relative to the housing portion 156. In some implementations, the actuating portion 200 may be split into two portions to correspond with the first portion 180 and the second portion 182 of the housing portion 156.

In some implementations, the cable sealing device 150 may be closed upon the cable 102 in the same manner as described with the cable sealing device 100 of FIGS. 2-6. Once closed, to displace or deform the sealing portion 157 causing a part of the sealing member 157 to extend through the first opening 170 to form an exterior sealing portion 186, the actuating portion 200 may be threaded into the housing portion 156 such that the actuating portion 200 may move longitudinally, relative to the housing portion 156, toward the first end portion 158. Thus, the actuating portion 200 may act as a piston or plunger by applying a longitudinally-directed force onto the sealing portion 157 to force a part the sealing portion 157 out of the first receiving portion 170 to form the exterior sealing portion 186.

The sealing portion 157 may seal against the wall portion 105 of the enclosure 103 and around the cable 102 in the same manner described with the cable sealing device 100 of FIGS. 2-6.

FIG. 8 illustrates an example cable sealing device 250 for the cable 102 (e.g., a communication cable such as a fiber optic cable). The cable sealing device 250 of FIG. 8 may be substantially similar to the cable sealing device 100 of FIGS. 2-6 and the description of the cable sealing device 100 may apply equally to the cable sealing device 250. For example, the cable sealing device 250 may include a housing portion 256 and a sealing portion 257. In some implementations, the housing portion 256 may be structurally configured to mount onto the cable 102 and may be structurally configured to house at least a part of the sealing portion 257.

In some implementations, the housing portion 256 may have a first end portion 258 with a first end face portion 260 and a second end portion 262 with a second end face portion 264 opposite the first end face portion 260. The housing portion 256 may have a longitudinal axis A and may include one or more sidewall portions 266 extending between the first end portion 258 and the second end portion 262.

The one or more sidewall portions 266, the first end portion 258, and the second end portion 262 may define an interior space 268. In some implementations, the first end portion 258 may include a first receiving portion 270 extending through the first end portion 258 from the first end face portion 260 to the interior space 268. The first receiving portion 270 may be structurally configured to receive the cable 102 therethrough and may have a first diameter D1. In some implementations, the second end portion 262 may include a second receiving portion 272 extending through the second end portion 262 from the second end face portion 264 to the interior space 268. The second receiving portion 272 may be structurally configured to receive the cable 102 therethrough and may have a second diameter D2.

The housing portion 256 may be structurally configured to mount onto the cable 102 in a variety of ways. In some implementations, the housing portion 256 may be structurally configured to open along a length of the housing portion 256 to receive the cable 102 within the interior space 268. For example, in some implementations, the housing portion 256 may include a first portion 280 (e.g., top portion or right portion) and a second portion 282 (e.g., bottom portion or left portion) opposite the first portion 280. The first portion 280 may be structurally configured to move relative to the second portion 282, or vice versa, between an open state and a closed state, similar to the cable sealing device 100.

In some implementations, the sealing portion 257 may be structurally configured to create a seal (e.g., water-proof seal) between the housing portion 256 and the cable 102 and between the first end face portion 260 and the wall portion 105 of the enclosure 103 surrounding the pass-through port 104 (FIG. 1). Unlike the cable sealing device 100 where, when the cable sealing device 100 moves to the closed state, the sealing member 107 may be displaced or deformed to extend out of the interior space 118 through the first opening 120, the sealing portion 257 of the cable sealing device 250 is preformed to have an interior portion 284 and an exterior portion 286.

In some implementations, the interior portion 284 may be structurally configured to reside in the interior space 268 and to form a seal against the cable 102. In some implementations, the exterior portion 286 may be structurally configured to form a seal between the first end face portion 260 and the wall portion 105 of the enclosure 103 surrounding the pass-through port 104.

In some implementations, the interior portion 284 may be structurally configured to reside in the interior space 268 and form a seal against the cable 102. In some implementations, the exterior portion 286 may be structurally configured to form a seal between the first end face portion 260 and the wall portion 105 of the enclosure 103 surrounding the pass-through port 104.

The sealing member 257 may be structurally configured in a variety of ways, including shape, size, materials, etc. In some implementations, the sealing member 257 includes one or more elastomers (e.g., PTFE, Nitrile (Buna), Neoprene, EPDM Rubber, Fluorocarbon (Viton), Silicon, etc.). In some implementations, the interior portion 284 may be generally cylindrical, the exterior portion 286 may be generally toroid-shaped (e.g., donut shaped), and the interior portion 284 may be connected to the exterior portion 286 by a reduced diameter neck portion 288. In some implementations, the sealing portion 257 may include a longitudinal passage 290 extending through the sealing portion 257 and structurally configured to receive the cable 102. In some implementations, the sealing portion 257 may be split into two portions to correspond with the first portion 280 and the second portion 282 of the housing portion 256.

When the cable 102 is received through the longitudinal passage 290 and the cable sealing device 250 is in the closed state, the sealing portion 257 may surround and forms a seal around the cable 102. To seal against the wall portion 105 of the enclosure 103, the cable sealing device 250 may be positioned adjacent the wall portion 105 such that the exterior portion 286 is sandwiched (e.g., compressed) between the wall portion 105 and the first end face portion 260 to seal around the pass-through port 104.

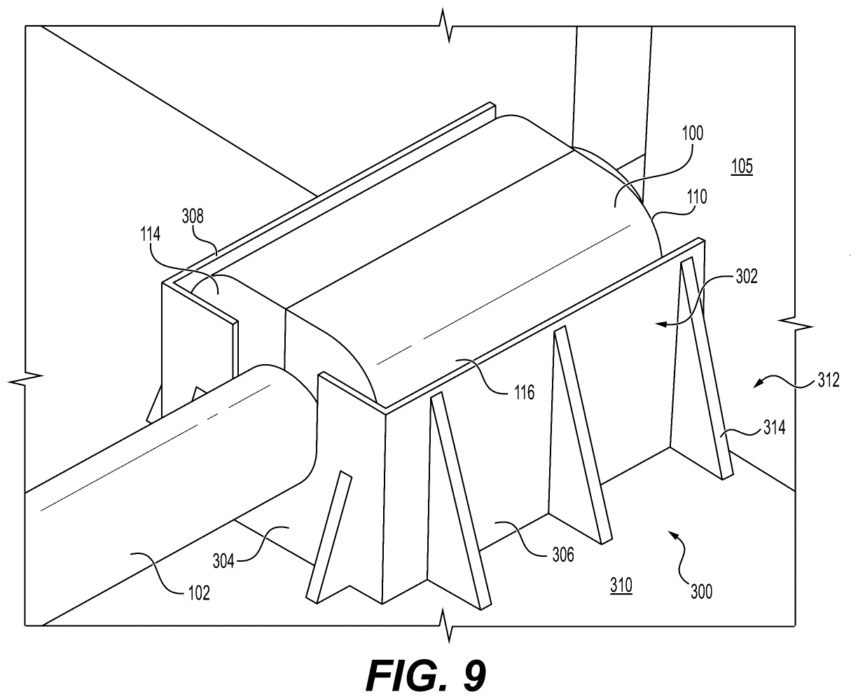

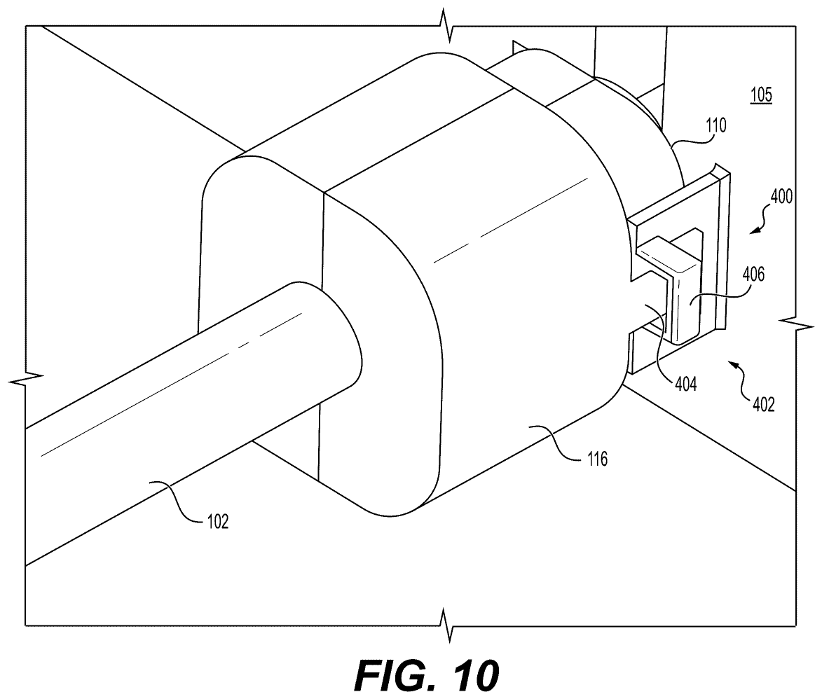

FIG. 9 illustrates an example supporting portion 300 structurally configured to help maintain the seal between the wall portion 105 of the enclosure 103 and the first end face portion of any of the disclosed cable sealing devices (e.g., the first end face 110 of the cable sealing device 100). The supporting portion 300 may be structurally configured to keep the cable sealing device 100 in position relative to the enclosure 103 to prevent the cable sealing device 100 from being moved, such as by tension on the cable 102. The supporting portion 300 may be configured in a variety of ways.

As shown in FIG. 9, in some embodiments, the supporting portion 300 may include an enclosing portion 302 having a rear wall portion 304, a first side wall portion 306 extending from the rear wall portion 304, and a second side wall portion 308 opposite the first side wall portion 306 and extending from the rear wall portion 304. In some embodiments, the rear wall portion 304 may be structurally configured to engage, or be adjacent to, the second end face portion 114. In some embodiments, the first side wall portion 306 may be structurally configured to engage, or be adjacent to, one of the sidewall portions 116 and the second side wall portion 308 may be structurally configured to engage, or be adjacent to, another of the sidewall portions 116 opposite the first side wall portion 306.

Thus, in some embodiments, the enclosing portion 302 may be structurally configured to enclose, along with the wall portion 105 of the enclosure 103, a perimeter of the cable sealing device 100. In some embodiments, the cable sealing device 100 and the enclosing portion 302 may be supported on a surface 310 adjacent the wall portion 105 of the enclosure 103. In some embodiments, the rear wall portion 304 may be fixed to a surface 310 by any suitable means (e.g., fasteners, adhesive, etc.). In some embodiments, the first and second side wall portions 306, 308 may be fixed to the surface 310 and/or the wall portion 105 by any suitable means (e.g., fasteners, adhesive, etc.).

In some embodiments, the supporting portion 300 may include a strengthening portion 312 structurally configured to add strength to or brace the enclosing portion 302. The strengthening portion 312 may be configured in a variety of ways. In some embodiments, the strengthening portion 312 may include a plurality of projecting portions 314 (e.g., ribs, fins, buttresses, etc.) attached to and extending from one or more of the rear wall portion 304, the first side wall portion 306, and the second side wall portion 308.

FIG. 9 illustrates an example supporting portion 400 structurally configured to help maintain the seal between the wall portion 105 of the enclosure 103 and the first end face portion of any of the disclosed cable sealing devices (e.g., the first end face 110 of the cable sealing device 100). The supporting portion 400 may be structurally configured to keep the cable sealing device 100 in position relative to the enclosure 103 to prevent the cable sealing device 100 from being moved, such as by tension on the cable 102. The supporting portion 400 may be configured in a variety of ways.

In some embodiments, the supporting portion 400 may include a fastening portion 402 structurally configured to fasten or secure the cable sealing device 100 to the wall portion 105 of the enclosure 103. The fastening portion 402 may be configured in a variety of ways. In some embodiments, the fastening portion 402 may include a latching portion 404 structurally configured to engage with a catching portion 406 to create, for example, a snap fit connection.

For example, in some embodiments, the catching portion 406 may be mounted on the wall portion 105 (e.g., two catching portions spaced apart about the width of the cable sealing device 100) and structurally configured to receive and retain the latching portion 404. The latching portion 404 may be mounted on the cable sealing device 100 and extend forward (e.g., two latching portions extending from forward from opposite sides of the cable sealing device 100). The cable sealing device 100 may be attached to the wall portion 105 of the enclosure by connecting (e.g., snapping) the latching portion 404 into the catching portion 406.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A sealing device structurally configured to form a watertight seal where a communication cable is received through a pass-through port, comprising:
a housing portion structurally configured to mount onto a communication cable, the housing portion comprising:
a first end face portion having a first receiving portion structurally configured to receive the communication cable therethrough;
a second end face portion having a second receiving portion structurally configured to receive the communication cable therethrough, wherein the second end face portion is opposite the first end face portion; and
a sidewall portion extending between the first end face portion and the second end face portion, wherein the sidewall portion, the first end face portion, and the second end face portion are configured to define an interior space;
a sealing portion at least partially positioned in the interior space;
wherein the sealing portion is structurally configured to create a water-proof seal between the housing portion and a communication cable;
wherein the housing portion includes a first housing portion and a second housing portion;
wherein the first housing portion is connected to the second housing portion by a hinged connection portion;
wherein the first housing portion is structurally configured to pivot relative to the second housing portion between an open state, wherein the interior space, the first receiving portion, and the second receiving portion are structurally configured to receive a communication cable, and a closed state, wherein the first housing portion and the second housing portion are structurally configured to surround the communication cable as the communication cable extends through the interior space, the first receiving portion, and the second receiving portion;
wherein the first receiving portion comprises a first opening having a first diameter and the second receiving portion comprises a second opening having a second diameter that is smaller than the first diameter; and
wherein the first housing portion and the second housing portion are structurally configured, when closing around the communication cable, to deform the sealing portion such that a part of the sealing portion is urged from the interior space through the first receiving portion so as to form a waterproof sealing portion outside of the interior space and that is structurally configured to seal around the communication cable outside of the interior space and to seal between the first end face portion and a surface surrounding a cable pass-through port associated with a submersible enclosure wherein the communication cable extends through the cable pass-through port to enhance simplicity of installation and sealing effectiveness of the sealing device.

2. The sealing device of claim 1, further comprising an actuating portion structurally configured to deform the sealing portion such that the part of the sealing portion is urged from the interior space through the first opening, wherein the actuation portion is structurally configured to thread into the housing portion.

3. The sealing device according to claim 1, further comprising a retaining portion structurally configured to lock the housing portion in the closed state.

4. A sealing device structurally configured to form a watertight seal where a communication cable is received through a pass-through port, comprising:
a housing portion structurally configured to mount onto a communication cable, the housing portion comprising:
a first end portion having a first receiving portion structurally configured to receive the communication cable therethrough;
a second end portion having a second receiving portion structurally configured to receive the communication cable therethrough;
a sidewall portion extending between the first end portion and the second end portion, wherein the sidewall portion, the first end portion, and the second end portion are structurally configured to define an interior space;
a sealing portion at least partially positioned in the interior space;
wherein the sealing portion is structurally configured to create a water-proof seal between the housing portion and a communication cable;
wherein the first receiving portion comprises a first opening having a first diameter and the second receiving portion comprises a second opening having a second diameter that is smaller than the first diameter; and
wherein the housing portion is structurally configured to deform the sealing portion such that a part of the sealing portion is urged from the interior space through the first receiving portion so as to form a waterproof sealing portion that structurally configured to seal around the communication cable outside of the interior space and to seal between the first end portion and a surface surrounding a cable pass-through port associated with a submersible enclosure wherein the communication cable extends through the cable pass-through port to enhance simplicity of installation and sealing effectiveness of the sealing device.

5. The sealing device according to claim 4, wherein the housing portion includes a first housing portion structurally configured to move relative to a second housing portion.

6. The sealing device according to claim 5, wherein the first housing portion is structurally configured to pivot relative to the second housing portion between an open state, wherein the interior space, the first receiving portion, and the second receiving portion are structurally configured to receive a communication cable, and a closed state, wherein the first housing portion and the second housing portion are structurally configured to surround the communication cable as the communication cable extends through the interior space.

7. The sealing device according to 6, further comprising a retaining portion structurally configured to lock the first housing portion and the second housing portion in the closed state.

8. The sealing device according to claim 4, further comprising an actuating portion structurally configured to move within the interior space to apply a force to the sealing portion to form the waterproof sealing portion that is outside of the interior space.

9. The sealing device according to claim 8, wherein the actuating portion is structurally configured to thread into the housing portion to apply an axial force onto the sealing portion.

10. A sealing device structurally configured to form a watertight seal where a communication cable is received through a pass-through port, comprising:
a housing portion defining an interior space structurally configured to receive a communication cable extending therethrough;
a sealing portion at least partially positioned in the interior space;
wherein the sealing portion and housing portion are structurally configured to surround the communication cable as the communication cable extends through the interior space;
wherein the sealing portion is structurally configured to create a water-proof seal between the housing portion and the communication cable; and
wherein the housing portion is structurally configured to deform the sealing portion such that a part of the sealing portion is urged from the interior space to form a waterproof sealing portion that is outside of the interior space and that is structurally configured to seal around the communication cable outside of the interior space and to seal between the housing portion and a surface surrounding a cable pass-through port associated with a submersible enclosure wherein the communication cable extends through the cable pass-through port to enhance simplicity of installation and sealing effectiveness of the sealing device.

11. The sealing device according to claim 10, wherein the housing portion includes a first end portion having a first receiving portion structurally configured to receive the communication cable therethrough.

12. The sealing device according to claim 11, wherein the housing portion includes a second end portion having a second receiving portion structurally configured to receive the communication cable therethrough, wherein the second end portion is opposite the first end portion.

13. The sealing device according to claim 12, wherein the housing portion includes a sidewall portion extending between the first end portion and the second end portion, wherein the sidewall portion, the first end portion, and the second end portion define the interior space.

14. The sealing device according to claim 12, wherein the first receiving portion comprises a first opening having a first diameter and the second receiving portion comprises a second opening having a second diameter that is smaller than the first diameter, and wherein the part of the sealing portion that is urged from the interior space extends through the first opening.

15. The sealing device according to claim 10, wherein the housing portion includes a first housing portion structurally configured to move relative to a second housing portion between an open state, wherein the interior space is structurally configured to receive the communication cable, and a closed state, wherein the first housing portion and the second housing portion are structurally configured to surround the communication cable as the communication cable extends through the interior space.

16. The sealing device according to claim 15, wherein the first housing portion is structurally configured to pivot relative to the second housing portion.

17. The sealing device according to claim 16, wherein the first housing portion is connected to the second housing portion by a hinged connection portion.

18. The sealing device according to claim 15, further comprising a retaining portion structurally configured to lock the first housing portion and the second housing portion in the closed state.

19. The sealing device according to claim 10, further comprising an actuating portion structurally configured to move within the interior space to apply a force to the sealing portion to form the waterproof sealing portion that is exterior to the housing portion.

20. The sealing device according to claim 19, wherein the actuation portion is structurally configured to thread into the housing portion to apply an axial force onto the sealing portion.

21. The sealing device according to claim 10, further comprising a supporting portion structurally configured to secure the housing portion in position relative to the surface surrounding the cable pass-through port.
